(19) United States
(12) Patent Application Publication
(10) Pub. No.: US 2020/0023896 A1
(43) Pub. Date: Jan. 23, 2020

(54) SYSTEM CAPABLE OF ENABLING WHEELS TO TURN TO ANY ANGLE AND COOPERATE WITH EACH OTHER AT DIFFERENT TURNING ANGLES

(71) Applicant: Sentai CHEN, Beijing (CN)

(72) Inventor: Sentai CHEN, Beijing (CN)

(21) Appl. No.: 16/477,480

(22) PCT Filed: Jan. 11, 2018
(86) PCT No.: PCT/IB2018/050172

§ 371 Date: Oct. 10, 2019

(30) Foreign Application Priority Data
Jan. 11, 2017 (CN) 201710033701.9
Jan. 11, 2017 (CN) 201720056068.0

(51) Int. Cl. B62D 7/15

(52) U.S. Cl. CPC B62D 7/1509; B62D 7/1527

(57) ABSTRACT

This disclosure is an auxiliary system to provide additional power for vehicles which can be applied to land wheel type vehicles without depending on rails, to convert most of the front-wheels drive and rear-wheel drive vehicles to multi-power all-wheel drive vehicles with low cost. Modification can be completed by merely three steps: 1. Arranging this disclosure on a non-driving wheel shaft. 2. Connecting the control box (1) with the brakes (7), a gas pedal (8) and the dashboard. 3. Placing the rechargeable battery packs (6) to the spare position of the vehicle. Adding one to a plurality of motors (5) which are additionally arranged on a non-drive shaft and controlled by the controlled box (1) according to the single-chip microcomputer (2) in the control box to decide whether to apply the auxiliary power according to preset commands, the status and speed of the vehicle, and signals transmitted by the brakes (7) and a gas pedal (8) of the vehicle. The advantages of this disclosure are of being capable to widely install on existing gas vehicles to provide auxiliary power without changing the current vehicles' systems and the modification cost is low.

### TECHNICAL FIELD

This disclosure is an auxiliary system to provide additional power for vehicles which can be applied to land wheel type vehicles without depending on rails, to convert most of the front-wheels drive and rear-wheel drive vehicles to multi-power all-wheel drive vehicles with low cost, the multi-power comprises but not limited to various fuels such as oil, gas, electricity, hydrogen fuel and various other fuels.

### BACKGROUND ART

At present, the most basic classification standard adopted by the vehicle is according to the number of the driving wheels, and can be divided into two-wheel drive and four-wheel drive. In the two-wheel drive type, the advantages of a rear-wheel drive are as follows: (i) of being good in controllability, (ii) good performance in starting stage and acceleration and comfortable during above processes, (iii) maintenance is easy. The disadvantages of a rear-wheel drive are as follows: (i) relatively higher cost and the space utilization are less convenient, (ii) the fraction force is insufficient and often over turns for a vehicle, (iii) and higher power loss. The advantages of a front-wheel drive are as follows: (1) lower manufacturing cost and high power efficiency, (ii) lighter vehicle weight, (iii) increase interior cabin space. The disadvantages of a front-wheel drive are as follows: poor controllability, (ii) insufficient vehicle turns, (iii) too much load on the front axle so the comfort level decreased. All-wheel drive refers to that the front wheel and the rear wheel of the vehicle are all powered, and the output torque of the engine can be distributed on all the wheels and the output torque can be applied to different wheels in different proportions according to road conditions so as to improve the performance of vehicle.

The current gas-electricity hybrid electric vehicle has good fuel economy performance and excellent in driving performance. The engine of the hybrid electric vehicle uses gas and fuel economy performance is good because of the electric motor during starting stage and acceleration, In short, the fuel consumption of a hybrid electric vehicle is lower than that of the vehicle with the same size. The power system of the hybrid electric vehicle is mainly composed of a control system, a driving system, an auxiliary power system, a battery pack and the like.

### BRIEF SUMMARY OF THE DISCLOSURE

This disclosure provides an auxiliary system to provide additional power for vehicles which can be additionally arranged on most land wheel type vehicles without depending on rails.

### THE TECHNICAL CHARACTERISTICS OF THE DISCLOSURE

However, a single power system vehicle just coming out of a factory is NOT equipped with this technical convenience which waste energy. The two-wheel driving type vehicles cannot solve the problems when the vehicle power is insufficient during the starting stage or climbing where too much loading of the engine occurs.

### THE TECHNICAL SCHEME

The technical scheme adopted by this disclosure is adding one to a plurality of motors which are additionally arranged on a non-drive shaft and controlled by the controlled box according to the single-chip microcomputer in the control box to decide whether to apply the auxiliary power according to preset commands, the status and speed of the vehicle, and signals transmitted by the brakes and a gas pedal of the vehicle. The energy of the system is supplied by the independent rechargeable battery pack which can be charged by utilizing the kinetic energy of the vehicle when the vehicle is running by kinetic energy or by gas, or is braking to slow down.

According to above technical scheme, a more specific technical scheme can also be that one to a plurality of motor devices are arranged on an existing non-transmission wheel. The motor can rotate the shaft so that the vehicle becomes an all-wheel drive vehicle when the vehicle is operated at a low speed. When the gas pedal is stepped, the motor rotates and provide energy to move the vehicle. The motor works when the vehicle moves at a low speed. The disclosure does not require modifying an engine, a transmission, braking devices, steering devices and refrigerating devices, so that most of the front-wheel drive and rear-wheel drive vehicles can be modified into a multi-power hybrid vehicle at extremely low cost.

The electric motor outputs power while the vehicle moves at a low speed and the electric motor becomes an electrical generator to charge the rechargeable battery pack when vehicle moves at a high speed. When the vehicle speed is higher than a certain preset speed per hour, the preset speed is adjustable, such as 40 kilometers or 60 kilometers per hour, the motor becomes a generator, so that the kinetic energy can be converted into electrical energy and stored in the rechargeable battery pack. When the vehicle is braking to slow down, the motor can also be used as a generator to charge the rechargeable battery pack. The preset speed for the motor to switch to the generator is adjustable.

Due to the adoption of the above technical scheme and to compare with the prior art, the advantages of this disclosure are of being capable to widely install on existing gas vehicles to provide auxiliary power without changing the current vehicles' systems, and the modification cost is low while modification can be completed by merely three steps.

1. Arranging this disclosure on a non-driving wheel shaft.

2. Connecting the control box with the brakes, a gas pedal and the dashboard.

3. Placing the rechargeable battery packs to the spare position of the vehicle.

The technical characteristics of this disclosure:

This disclosure is an auxiliary system to provide additional power for vehicles which can be applied to land wheel type vehicles without depending on rails, including a control box, a single-chip microcomputer, a motor drive, a control operation interface, motors, rechargeable battery packs, brakes, a gas pedal, tires, axles, the central wheel hubs, inner layer rotating motors, outer layer rotating motors, suspension systems, brake discs, bearings, where a single-chip microcomputer and a motor drive are contained in the control box which is a center of the system, and the control box is respectively connected to brakes, motors, a gas pedal, rechargeable battery packs, and the control box control motors to provide power when the wheel type vehicle moves from the static status and low-speed movements, and to convert kinetic energy into electrical energy to be stored in the rechargeable battery packs during high-speed movements and the braking to slow down movements where the motors become generators, multi-power includes but not limited to gas, electricity, hydrogen fuel and various fuels, and one to multiple motor devices are equipped on existing non-transmission wheels; the motor can rotate the wheel, so that the vehicle becomes all-wheel drive or multi-transmission, a motor is mounted on the outer side of the suspension system and the motor is simultaneously mounted in the center of the wheel hub, wherein the connecting sequence from the inner side to the outer side of the vehicle is a suspension system, a motor and a hub, due to the fact that the motor rotates the hub, the original non-transmission shaft wheel can rotate from a passive rotation to an active rotation, and an inner layer rotating motor (12) is installed in the central wheel hub (11) where an inner layer rotating motor (12) rotates the wheel to move the vehicle, and an inner layer rotating motor (12) is mounted on the suspension system (14) by mechanical parts and the brake discs (15) are wrapped outside the central wheel hub (11); the outer layer rotating motor (13) replaces the function of the central wheel hub (11) in which the outer layer rotating motor (13) is mounted on the rim, as the outer layer rotating motor (13) rotates the wheel to move the vehicle where the outer layer rotating motor (13) is compriseded with mechanical parts and bearings (16) and are connected to the suspension system (14), the bearings are used for rotation, and the brake discs (15) cover the outer layer rotating motor (13).

The characteristics of the inner layer rotating motor described in the disclosure are as follows, wherein the inner layer rotating motor is installed in a central wheel hub and the inner layer rotating motor rotates the rim to rotate the tire, the center rotating motor is mounted on the suspension system by mechanical parts and the brake discs cover the central wheel hub.

The characteristics of the outer layer rotating motor described in the disclosure are as follows, wherein the outer layer rotating motor replaces the function of the central wheel hub and is mounted on the rim, as the outer layer rotating motor rotates the rim to rotate the tire, the outer layer rotating motor is comprised with mechanical parts connected to the suspension system and bearings which are used for rotation and the brake discs cover the outer layer rotating motor.

The characteristics of the control box described in the disclosure are as follows, wherein the control box is composed of a single-chip microcomputer and a motor drive and is connected respectively to the motor, rechargeable battery packs, brakes which can be used for judging and sending signals to motor to act or to charge the rechargeable battery packs according to preset commands, vehicle speed, signals from the brakes and the gas pedal, and the control box can control the motor independently according to driver's instructions, or to collaborate with gas engine, or to act by preset mode and preset numbers which can be manually changing while driving.

The characteristics of the control box described in the disclosure are as follows, wherein the control box is connected to brakes and will immediately stops the motors as the brake is stepped down.

The characteristics of the single-chip microcomputer described in the disclosure are as follows, wherein the single-chip microcomputer is provided with a circuit, present commands and programs and connected to brakes, motors, a gas pedal, rechargeable battery packs and is capable to receive external signals to automatically judge the status of the vehicle and send out control commands.

The characteristics of the motor drive described in the disclosure are as follows, wherein the motor drive drives various small motors and functional components of the vehicle by circuits, helps to steer, enable the motor to have the function of an electrical generator to charge the rechargeable battery packs.

The characteristics of the motor described in the disclosure are as follows, wherein the motor is connected to the control box and is controlled through motor drive by the single-chip microcomputer and can adapt to frequent starting/stopping, accelerating/decelerating, high torque during low-speed or climbing, low torque during high-speed, with large variable speed range, collaborate with motor drive, has the function of a generator to charge rechargeable battery packs, the motor can be manually controlled by the control box and can also be controlled by the gas pedal, the motor can act independently, or to collaborate with gas engine at the sane time, and can be stopped immediately during braking, the motor enable the vehicle to all-wheel drive to adopt to complex terrains during low-speed, climbing, or starting.

### GOOD EFFECTS OF THE DISCLOSURE

The electric motor output high torque at low rotation and output low torque at high rotation; The gasoline engine output low torque at a low rotation and output high torque at high rotation, so the electric motor and gasoline engine are perfect to collaborate to each other, the high torque during starting and low speed can improve fuel efficiency; during high speed of a vehicle, the motor is no longer required and can be converted into a generator so the kinetic energy is converted into electrical energy to be stored in the rechargeable battery packs and a good complementation effect is achieved, the system can provide auxiliary power without modifying an engine, a transmission, braking devices, steering devices, refrigerating devices so that most of the front-wheel drive and rear-wheel drive vehicles can be modified into a multi-power hybrid vehicle at extremely low cost.

### BRIEF DESCRIPTION OF THE DRAWINGS

FIG. 1 is the concept drawing and illustrates the major structure of the disclosure.

FIG. 2 is a section drawing of the disclosure, illustrates how to install an inner layer rotating motor to rim and connect to suspension system.

FIG. 3 is a section drawing of the disclosure, illustrates how to install an outer layer rotating motor to rim and connect to suspension system.

### DETAILED DESCRIPTION OF THE EMBODIMENTS

The disclosure is further explained by combining the drawings and embodiments, and the applications are explained. The following description is presented to enable one of ordinary skill in the art to make and use the disclosure and is provided in the context of a patent application and its requirement. Various modifications to the preferred embodiments and the generic principles described herein will be readily apparent to those skilled in the art. Thus, the present disclosure is not intended to be limited to the embodiments shown but is to be accorded the widest scope consistent with the principles and features described herein.

### Embodiment 1:

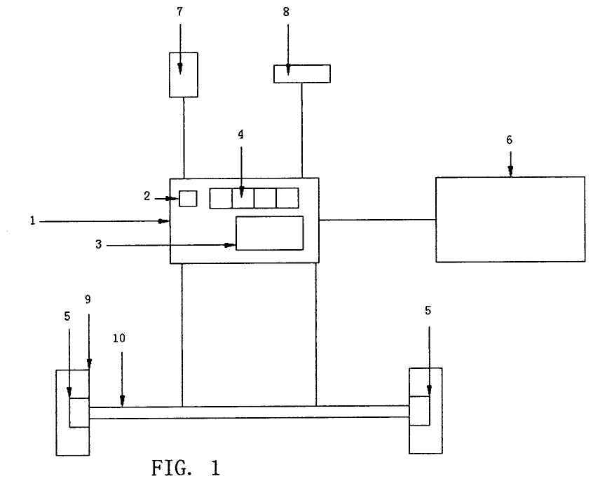

As shown in FIG. 1, one or more motors (5) are mounted on a non-transmission shaft of a vehicle, and a single-chip microcomputer (2) in a control box (1) can judge whether the auxiliary power is needed or not according to preset commands, the vehicle speed, signals from braking and the gas pedal, and the specific judgment methods refer to embodiment 6, 7 and 8.

### Embodiment 2:

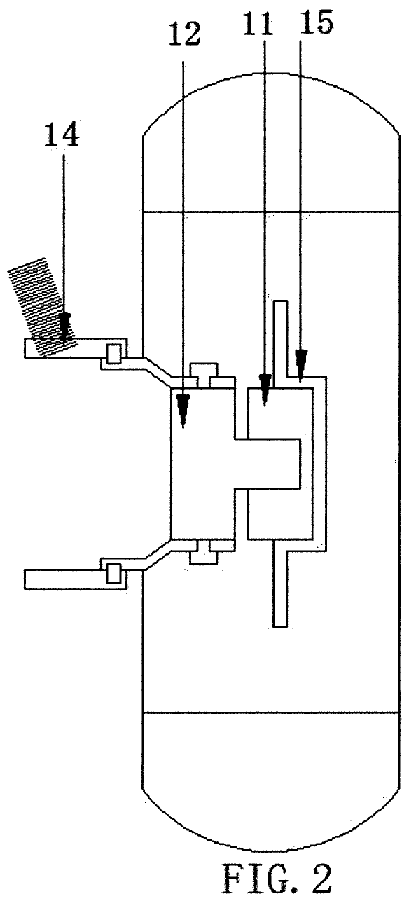

As shown in FIG. 2, the inner layer rotating motor (12) is mounted in the central wheel hub (11) as the inner layer rotating motor (12) rotates the rim to rotate the tire and the inner layer rotating motor (12) is mounted by mechanical parts to suspension system (14) while the brake discs are wrapped outside the central wheel hub.

### Embodiment 3:

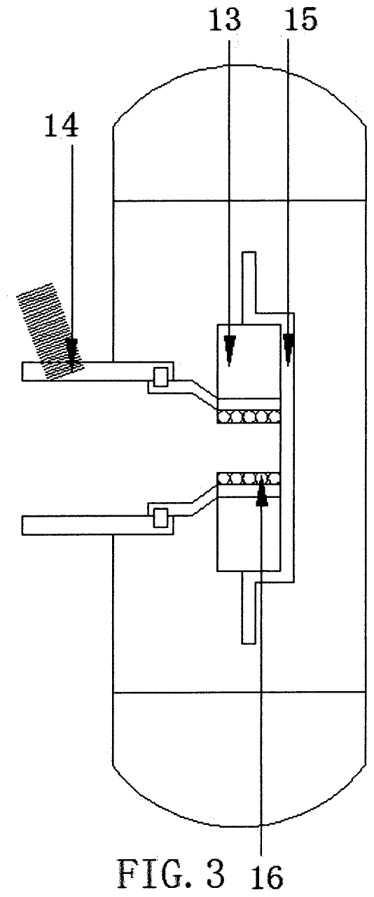

As shown in FIG. 3, the outer layer rotating motor (13) replaces the function of the central wheel hub (11), the outer layer rotating motor (13) is mounted in the rim as the outer layer rotating motor (13) rotates the rim to rotate the tire and the outer layer rotating motor (13) is comprised with mechanical parts connected to the suspension system (14) and bearings (16) which are used for rotation and the brake discs (15) cover the outer layer rotating motor (13).

### Embodiment 4:

As shown in FIG. 1, the drive step the gas pedal when the vehicle is static, since the gas pedal is connected to the control box (1), and the motor drive (3) of the control box (1) can drive the motor (5), so that the gas engine of the vehicle can work simultaneously with the motor (5) and the vehicle start to move.

### Embodiment 5:

As shown in FIG. 1, the drive can control the output of motor (5) by control box (1) which can be preset to several modes including but not limited to: from small output to large output, from large output to small output, directly to the highest rotating speed and the maximum output, and in order to adjust output ratio between gas engine of the vehicle to motor (5), these preset modes and numbers can be manually switched and changed during driving.

### Embodiment 6:

As shown in FIG. 1, FIG. 1 illustrates how a gas pedal controls the motor (5) through a control box (1) which means that a driver can control independently the output of the motor (5) by the control box (1) without stepping the gas pedal since it doesn't consume gas if a drive doesn't step a gas pedal to use gas engine but use electric motor (5) ONLY because traffic jam in the city with lots of starting and stopping costs most fuel consumption and wait until to drive with a stable speed to step the gas pedal.

The ways that a driver can use only the control box (1) to control the output of motor (5) are including but not limited to (i) use two buttons of strong button and weak button to control independently the rotation speed and output strength of the motor (5), (ii) use adjusting valve to control independently the rotation speed and output strength of the motor, (iii) use a manual rod to control independently the rotation speed and output strength of the motor (5), and the like.

### Embodiment 7:

As shown in FIG. 1, FIG. 1 illustrates how brakes control motor (5) through the control box (1) as the driver step down the brake, since the brakes (7) are connected to the control box (1) so the control box (1) immediately stops the motor dive so the motor (5) stops immediately.

### Embodiment 8:

It illustrates how vehicle speed control motor (5) through the control box (1), for example, when the vehicle speed is lower than 50 kilometers per hour, the single-chip microcomputer (2) will send instructions to start to provide auxiliary power and the energy is provided by independent rechargeable battery packs (6); when the vehicle speed is over 50 kilometers per hour, the single-chip microcomputer (2) of control box (1) will control motor drive (3) and motor (5) to convert an electric motor (5) to a generator so the kinetic energy of the vehicle can be utilized to charge the independent rechargeable battery packs (6).

The foregoing description of illustrated embodiments of the present disclosure, including what is described in the Abstract, is not precise forms disclosed herein. While specific embodiments of and examples for, the disclosure are described herein for illustrative purposes only, various equivalent modifications are possible within the spirit and scope of the present disclosures, as those skilled in the relevant art will recognize and appreciate. As indicated, these modifications may be made to the present disclosure in light of the foregoing description of illustrated embodiments of the present disclosure and are to be included within the spirit and scope of the present disclosure.

### THE DESCRIPTIONS OF PARTS CODING IN ASCENDING ORDER

The descriptions of parts coding:
1 Control box.
2 Single-Chip Microcomputer.
3 Motor Drive.
4 Control Operation Interface.
5 Motor.
6 Independent Rechargeable Battery Packs.
7 Brakes.
8 A Gas Pedal.
9 Tires.
10 An Axel
11 A Central Wheel Hub.
12 An Inner Layer Rotating Motor.
13 An Outer Layer Rotating Motor.
14 A Suspension System.
15 Brake Discs.
16 Bearings.

1. This disclosure is an auxiliary system to provide additional power for vehicles which can be applied to land wheel type vehicles without depending on rails, including a control box, a single-chip microcomputer, a motor drive, a control operation interface, motors, rechargeable battery packs, brakes, a gas pedal, tires, axles, the central wheel hubs, inner layer rotating motors, outer layer rotating motors, suspension systems, brake discs, bearings, where a single-chip microcomputer and a motor drive are contained in the control box which is a center of the system, and the control box is respectively connected to brakes, motors, a gas pedal, rechargeable battery packs, and the control box control motors to provide power when the wheel type vehicle moves from the static status and low-speed movements, and to convert kinetic energy into electrical energy to be stored in the rechargeable battery packs during high-speed movements and the braking to slow down movements where the motors become generators, multi-power includes but not limited to gas, electricity, hydrogen fuel and various fuels, and one to multiple motor devices are equipped on existing non-transmission wheels; the motor can rotate the wheel, so that the vehicle becomes all-wheel drive or multi-transmission, a motor is mounted on the outer side of the suspension system and the motor is simultaneously mounted in the center of the wheel hub, wherein the connecting sequence from the inner side to the outer side of the vehicle is a suspension system, a motor and a hub, due to the fact that the motor rotates the hub, the original non-transmission shaft wheel can rotate from a passive rotation to an active rotation, and an inner layer rotating motor (12) is installed in the central wheel hub (11) where an inner layer rotating motor (12) rotates the wheel to move the vehicle, and an inner layer rotating motor (12) is mounted on the suspension system (14) by mechanical parts and the brake discs (15) are wrapped outside the central wheel hub (11); the outer layer rotating motor (13) replaces the function of the central wheel hub (11) in which the outer layer rotating motor (13) is mounted on the rim, as the outer layer rotating motor (13) rotates the wheel to move the vehicle where the outer layer rotating motor (13) is compriseded with mechanical parts and bearings (16) and are connected to the suspension system (14), the bearings are used for rotation, and the brake discs (15) cover the outer layer rotating motor (13).

2. The auxiliary system to provide additional power for vehicles as set forth in claim 1, wherein the inner layer rotating motor is installed in a central wheel hub and the inner layer rotating motor rotates the rim to rotate the tire, the center rotating motor is mounted on the suspension system by mechanical parts and the brake discs cover the central wheel hub.

3. The auxiliary system to provide additional power for vehicles as set forth in claim 1, wherein the outer layer rotating motor replaces the function of the central wheel hub and is mounted on the rim, as the outer layer rotating motor rotates the rim to rotate the tire, the outer layer rotating motor is comprised with mechanical parts connected to the suspension system and bearings which are used for rotation and the brake discs cover the outer layer rotating motor.

4. The auxiliary system to provide additional power for vehicles as set forth in claim 1, wherein the control box is composed of a single-chip microcomputer and a motor drive and is connected respectively to the motor, rechargeable battery packs, brakes which can be used for judging and sending signals to motor to act or to charge the rechargeable battery packs according to preset commands, vehicle speed, signals from the brakes and the gas pedal, and the control box can control the motor independently according to driver's instructions, or to collaborate with gas engine, or to act by preset mode and preset numbers which can be manually changing while driving.

5. The auxiliary system to provide additional power for vehicles as set forth in claim 1, wherein the control box is connected to brakes and will immediately stops the motors as the brake is stepped down.

6. The auxiliary system to provide additional power for vehicles as set forth in claim 1, wherein the single-chip microcomputer is provided with a circuit, present commands and programs and connected to brakes, motors, a gas pedal, rechargeable battery packs and is capable to receive external signals to automatically judge the status of the vehicle and send out control commands.

7. The auxiliary system to provide additional power for vehicles as set forth in claim 1, wherein the motor drive drives various small motors and functional components of the vehicle by circuits, helps to steer, enable the motor to have the function of an electrical generator to charge the rechargeable battery packs.

8. The auxiliary system to provide additional power for vehicles as set forth in claim 1, wherein the motor is connected to the control box and is controlled through motor drive by the single-chip microcomputer and can adapt to frequent starting/stopping, accelerating/decelerating, high torque during low-speed or climbing, low torque during high-speed, with large variable speed range, collaborate with motor drive, has the function of a generator to charge rechargeable battery packs, the motor can be manually controlled by the control box and can also be controlled by the gas pedal, the motor can act independently, or to collaborate with gas engine at the same time, and can be stopped immediately during braking, the motor enable the vehicle to all-wheel drive to adopt to complex terrains during low-speed, climbing, or starting.
